(19) United States
(12) Patent Application Publication
(10) Pub. No.: US 2025/0139680 A1
(43) Pub. Date: May 1, 2025

(54) SEARCH DEVICE, SEARCH METHOD, AND RECORDING MEDIUM

(71) Applicant: Rakuten Group, Inc., Tokyo (JP)

(72) Inventors: Ryo NAGATA, Tokyo (JP); Nanako TAKAHASHI, Tokyo (JP)

(73) Assignee: Rakuten Group, Inc., Tokyo (JP)

(21) Appl. No.: 18/925,681

(22) Filed: Oct. 24, 2024

(30) Foreign Application Priority Data
Oct. 27, 2023 (JP) 2023-184947

(51) Int. Cl. G06Q 30/0601; G06Q 40/04

(52) U.S. Cl. CPC G06Q 30/0627; G06Q 30/0633; G06Q 30/0643; G06Q 40/04

(57) ABSTRACT

A search device includes a searcher to perform a conditional search to search for an object matching a search condition and generate a list including the object, an outputter to cause a user terminal to display the object included in the generated list on a display screen of the user terminal, and an acquirer to acquire drawn information indicating the object that is drawn on the display screen among the objects included in the list, and in a case where the acquired drawn object is not included in a new list generated by newly performing the conditional search based on the search condition, the searcher adds the drawn object to the new list.

### CROSS-REFERENCE TO RELATED APPLICATIONS

This application claims the benefit of Japanese Patent Application No. 2023-184947, filed on Oct. 27, 2023, the entire disclosure of which is incorporated by reference herein.

### FIELD OF THE INVENTION

This application relates to a search device, a search method, and a recording medium.

### BACKGROUND OF THE INVENTION

A technology for searching information stored in a database, based on a search condition has been known (for example, Unexamined Japanese Patent Application Publication No. 2002-259447).

In such a technology, there are some cases where even when a search is performed using the same search condition as a search condition used in the past, the same search result cannot be obtained due to an update of the database, a change in a search algorithm, or the like. Therefore, there has been a problem in that when in an electronic commerce site, a user searches for a product, glances at a displayed search result, and plans to view detail information later, the product is not displayed at the time of re-searching and the user cannot reconsider the search result again.

The present disclosure has been made in consideration of the above-described circumstances, and an objective of the present disclosure is to provide a search device, a search method, and a recording medium that enable information having been displayed in a previous search to be reconsidered again at the time of re-searching.

### SUMMARY OF THE INVENTION

In order to solve the above-described problem, a search device according to the present disclosure includes
one or more processors, and
the processors
perform a conditional search to search for an object matching a search condition and generate a list including the object,
cause a user terminal to display the object included in the generated list on a display screen of the user terminal,
acquire drawn information indicating the object that is drawn on the display screen among the objects included in the list, and
in a case where the acquired drawn object is not included in a new list generated by newly performing the conditional search based on the search condition, add the drawn object to the new list.

According to the present disclosure, a search device, a search method, and a recording medium that enable information having been displayed in a previous search to be reconsidered again at the time of re-searching can be provided.

### BRIEF DESCRIPTION OF DRAWINGS

A more complete understanding of this application can be obtained when the following detailed description is considered in conjunction with the following drawings, in which:

FIG. 1 is an explanatory diagram illustrating connections between a search device and other devices;

FIG. 2 is a diagram illustrating an example of a My List page displayed on a user terminal;

FIG. 3 is a diagram illustrating an example of a screen displayed on the user terminal to save a search condition;

FIG. 4 is an explanatory diagram illustrating a functional configuration of the search device;

FIG. 5 is a diagram illustrating an example of a search condition table generated by a search condition generator;

FIG. 6 is a diagram illustrating an example of index information stored in a product database;

FIG. 7 is a diagram illustrating an example of a search result list generated by a searcher;

FIG. 8 is a diagram illustrating an example of a displayed product table generated by a displayed product table generator;

FIG. 9 is an explanatory diagram illustrating a physical configuration of the search device;

FIG. 10 is a flowchart of search condition saving processing performed by the search device and the user terminal;

FIG. 11 is a flowchart of saved condition-based search processing performed by the search device and the user terminal;

FIG. 12A is a diagram illustrating another example of the search result list generated by the searcher; and

FIG. 12B is a diagram illustrating an example of a search result list updated by a changer.

### DETAILED DESCRIPTION OF THE INVENTION

A search device, a search method, and a recording medium according to an embodiment for embodying the present disclosure are described below in detail with reference to the drawings. Note that the same or corresponding parts in the drawings are designated by the same reference numerals. Note that the present embodiment is intended for description and is not intended to limit the scope of the present disclosure. Accordingly, it is possible for a person skilled in the art to employ an embodiment in which part or all of the elements of the embodiment are replaced by equivalents thereof, which are also included in the scope of the present disclosure.

### Overall Configuration

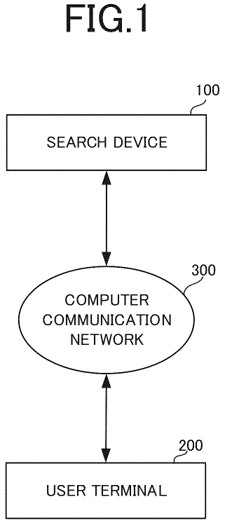

FIG. 1 is an explanatory diagram illustrating connections between a search device 100 and other devices. Hereinbelow, a description is made with reference to the drawing. As illustrated in FIG. 1, the search device 100 according to an embodiment of the present disclosure communicably connects to a user terminal 200 via a computer communication network 300, such as the Internet.

The search device 100 includes one or a plurality of server computers. The search device 100 is a device that a provider or the like providing an electronic commerce service, such as an online mall, an online shopping site, an auction site, and a flea market site, operates. The search device 100 performs saved condition-based search processing that outputs a search result corresponding to a saved search condition to the user terminal 200, with a product traded in the electronic commerce service as a search object. Note that the search device 100 may search for a service, such as travel, a restaurant, and a beauty salon provided at a reservation site, or a trading object provided at a financial product providing site, or may be a device to search for a web page on the Internet.

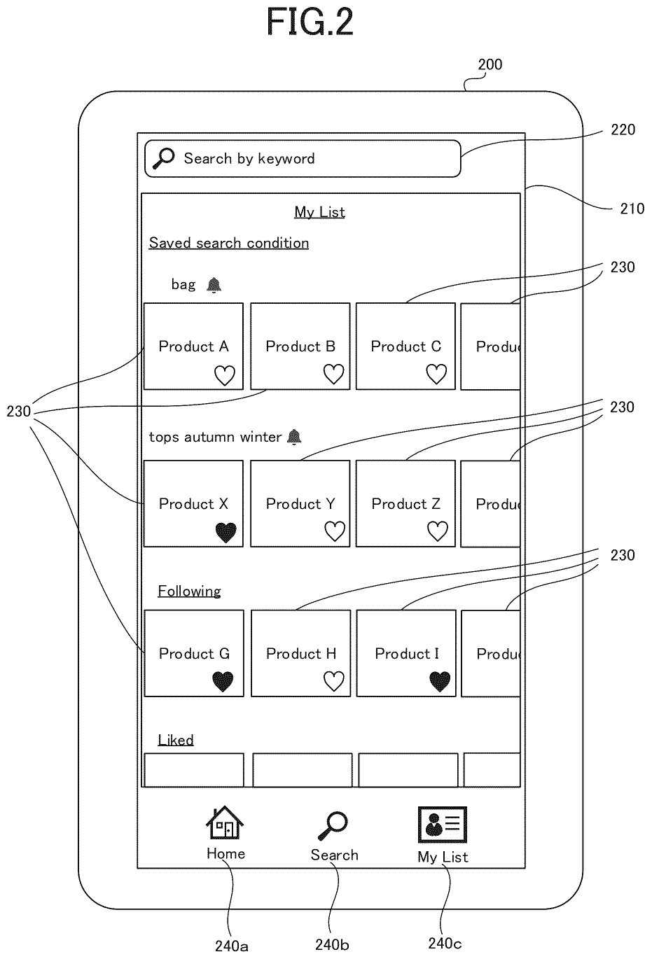

Specifically, the search device 100 causes the user terminal 200 to display a My List page in which a search result corresponding to a saved search condition (search keyword) is displayed. An example of the My List page is illustrated in FIG. 2. As illustrated in FIG. 2, the My List page includes a section called “saved search condition” in which a search result based on a saved search condition is displayed. The My List page includes the section “saved search condition” that is a section in which a search condition is displayed in conjunction with a search result based on the saved search condition. In the illustrated example, beneath a section name “saved search condition”, search keywords “bag” and “tops autumn winter” that are saved search conditions are displayed. In addition, beneath each search keyword, icons 230 of products that are summary information of a search result matching the search keyword are displayed in a scrollable manner to the right side of a display screen 210 of the user terminal 200. When a user performs an operation of scrolling the display screen 210 to the right side in an area on the display screen 210 in which icons 230 are arranged, an icon 230 of another product included in the search result is displayed on the display screen 210. In addition, when an icon 230 of one of the products is selected by the user, the screen transitions to a page that displays detail information of the product corresponding to the selected icon 230. In addition, each black heart mark included in an icon 230 (for example, a heart mark included in a product X or a product G) indicates that a product corresponding to the icon 230 is registered in a favorite list, and each white heart mark included in an icon 230 (for example, a heart mark included in an icon 230 of a product A or a product B) indicates that a product corresponding to the icon 230 is not registered in the favorite list. The user selecting a heart mark causes processing of registering a product corresponding to the heart mark in the favorite list or processing of removing the product from the favorite list to be performed. Note that in an upper part of the display screen 210, a search box 220 to input a search keyword is arranged. In addition, in a lower part of the display screen 210, an icon 240a to cause the screen to transition to a home screen, an icon 240b to cause the screen to transition to a screen for a search for a product, and an icon 240c to cause the screen to transition to the My List page are arranged.

The search device 100 performs search processing, based on a saved search condition and generates a search result list that indicates a list of products matching the search condition. The search device 100, searched by the same search condition used in the past, referring to a displayed product table that indicates a product corresponding to an icon 230 actually displayed on the display screen 210 of the user terminal 200, identifies a product that is not included in the generated search result list among products included in the displayed product table. Note that in the following description, an icon 230 that is displayed in a scrollable manner being actually displayed on the display screen 210, that is, the icon 230 being displayed in a visually recognizable manner, is also referred to as being drawn. In addition, a displayed icon 230 that is actually displayed on the display screen 210 is also referred to as a drawn icon 230 or an already-drawn icon 230.

The search device 100 adds an identified product to the search result list and causes the user terminal 200 to display icons 230 of products included in the updated search result list on the display screen 210 of the user terminal 200. Note that as illustrated as an example in FIG. 2, the My List page may include other sections, such as a section “following” in which a search result of a search for a product that a store, a seller, or the like that the user registered as a favorite puts up for sale, a product registered as a favorite by another user whom the user registered as a favorite, or the like is displayed and a section “Liked” in which an icon 230 of a product that the user registered as a favorite is displayed. In addition, the My List page may further include an arbitrary section, such as a section “recently checked” in which an icon 230 of a product the detail information of which the user browsed by selecting the icon 230 of the product is displayed.

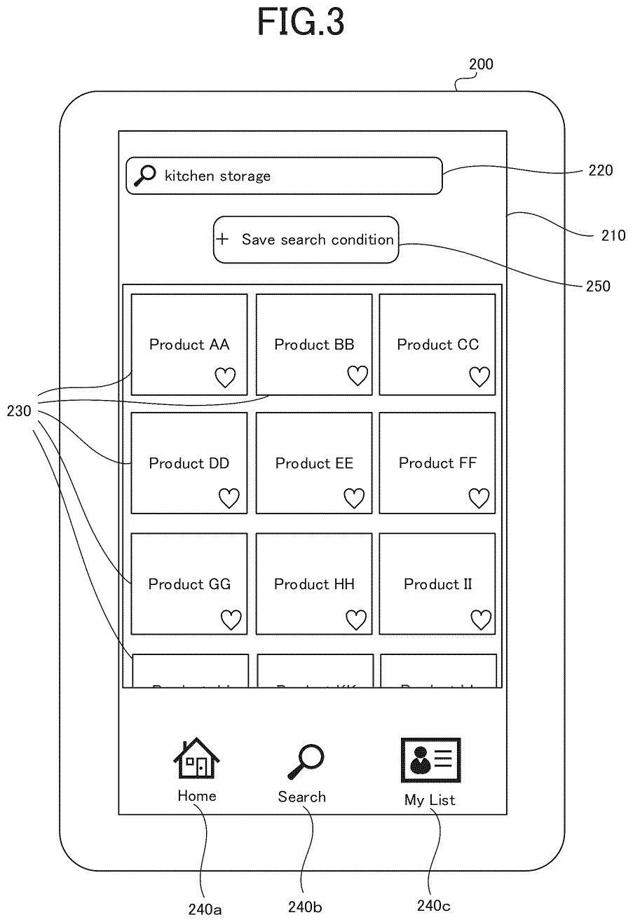

Returning to FIG. 1, the user terminal 200 is an information terminal (a so-called computer) that the user owns, such as a smartphone, a tablet, and a personal computer (PC), and is capable of mutually communicating with the search device 100 via the computer communication network 300. The user installs an electronic commerce app in the user terminal 200, starts the electronic commerce app, and uses an electronic commerce service provided by the search device 100. The user terminal 200 sets a search condition of a product, based on information input by the user and displays a search result of a search performed by the search device 100. An example of the display screen 210 of the user terminal 200 for setting a search condition is illustrated in FIG. 3. As illustrated, when words “kitchen storage” are input to the search box 220, to which a search keyword is input, by the user and a save button 250 for saving a search condition is pressed, the user terminal 200 causes the search device 100 to save a search condition that has “kitchen storage” as search keywords. The search device 100 generates and saves a search condition table in which a search condition of each user is stored. Note that when a search keyword is input to the search box 220, the user terminal 200 transmits a search query including the search keyword to the search device 100, and an icon 230 of a product matching the search keyword is displayed on the display screen 210.

In addition, the user terminal 200 transmits an icon ID for identifying a drawn icon 230 that is actually displayed on the display screen 210 and a time at which the drawn icon 230 was drawn, to the search device 100. The search device 100 generates a displayed product table that indicates a list of products corresponding to icons 230 drawn on the display screen 210 with respect to each saved search condition, based on received information.

### (Functional Configuration of Search Device)

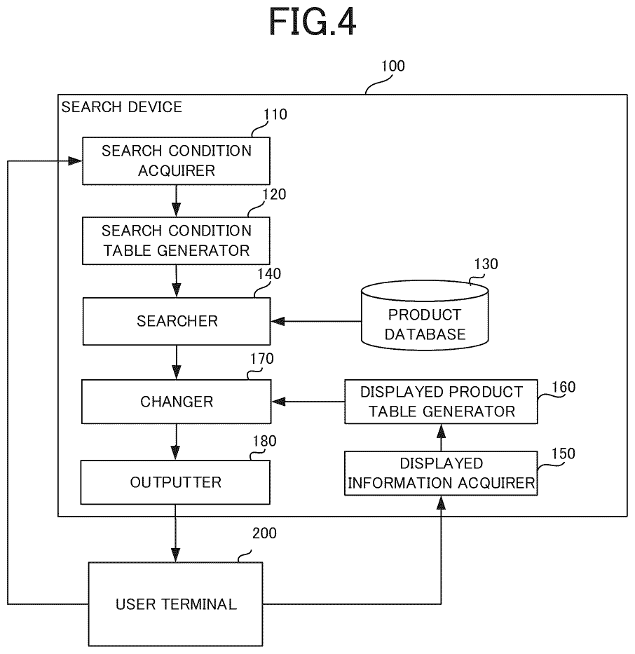

Next, using FIG. 4, a functional configuration of the search device 100 is described. The search device 100 includes a search condition acquirer 110, a search condition table generator 120, a product database 130, a searcher 140, a displayed information acquirer 150, a displayed product table generator 160, a changer 170, and an outputter 180.

The search condition acquirer 110 acquires a search condition from the user terminal 200. Specifically, when a search keyword is input through an input operation performed by the user, the user terminal 200 transmits the input search keyword to the search device 100. When the search condition acquirer 110 receives a search keyword, the search condition acquirer 110 transmits the received search keyword and a user ID of the user terminal 200 that transmitted the search keyword, to the search condition table generator 120. Note that the input of a search condition is not limited to a case where a search keyword is input and may be input performed by inputting an image or input performed by selecting attribute information, such as a category, size, color, and a maker, of a product from predetermined options.

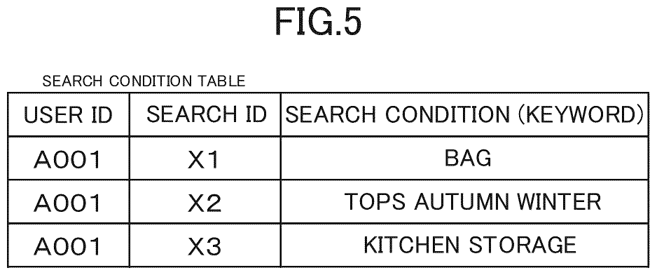

The search condition table generator 120 generates the search condition table, which indicates a search condition with respect to each user, based on the search condition acquired by the search condition acquirer 110. An example of the search condition table is illustrated in FIG. 5. The search condition table includes an item “user ID” for uniquely identifying a user, an item “search ID” for identifying a search condition, and an item “search condition (keyword)” indicating a search keyword that is a search condition. Note that although in the illustrated example, search conditions of only a user “A001” are stored, search conditions of other users may be likewise stored. In addition, information included in the search condition table is not limited to the above-described items and may be an image that is input as a search condition, attribute information selected from predetermined options, or the like.

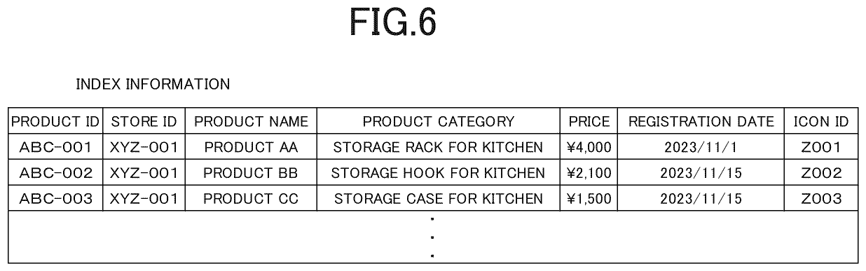

Returning to FIG. 4, the product database 130 is a database in which information relating to products traded in the electronic commerce service is stored. The product database 130 includes index information that serves as a comparison target with a saved search condition. An example of the index information is illustrated in FIG. 6. The index information includes pieces of information, such as a “product ID” that is information for uniquely identifying a product, a “store ID” that is information for uniquely identifying a store in which the product is put up for sale, a “product name” that indicates a name of the product, a “category name” that indicates a category of the product, a “price” that indicates a price of the product, and an “icon ID” for identifying an icon 230 of the product that is displayed on the user terminal 200. Note that although the index information in FIG. 6 is simplified, information about all products in all stores is included in an actual index information. In addition, information included in the index information is not limited to the above-described information, and arbitrary information, such as color and size of a product, a manufacturer of the product, and an address of a store, may be included. In addition, the product database 130 further stores information, such as link information of a web page in which detail information of each product is displayed and image data that serve as a basis for an icon 230 to be displayed on the user terminal 200.

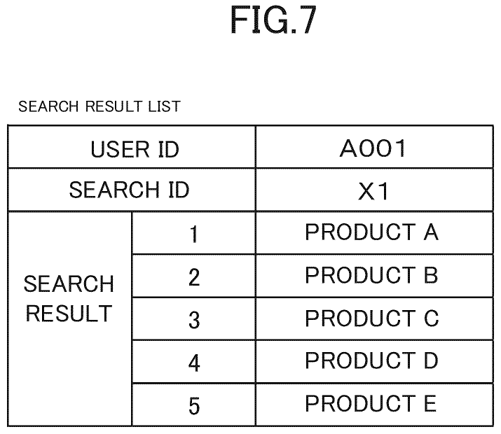

Returning to FIG. 4, the searcher 140 performs a product search, based on a search condition that has been saved or is input and generates a search result list that is a list of search results matching the search condition. Note that the searcher 140 may set an upper limit for the number of search results included in the search result list. Specifically, the searcher 140 performs a conditional search based on a search condition when the user starts the electronic commerce app and accesses the My List page or at a predetermined timing, such as every day and every week. The searcher 140 searches the index information stored in the product database 130, based on a keyword included in the search condition table generated by the search condition table generator 120 and generates a search result list including products matching the search condition. An example of the search result list is illustrated in FIG. 7. The search result list includes pieces of information about the “user ID” for uniquely identifying a user, the “search ID” for uniquely identifying a search condition with respect to each user, and a “search result” indicating a product name of a product matching the search condition. In the illustrated example, it is indicated that the user ID is “A001” and products matching a search condition having a search ID “X1” are a product A, a product B, a product C, a product D, and a product E. Note that the search result list may include a product ID in place of a product name or may include both a product name and a product ID. In addition, the search result list may include information indicating a time at which a search is performed.

Returning to FIG. 4, the displayed information acquirer 150 acquires information about a drawn icon 230 that is displayed on the display screen 210 in a visually recognizable manner, from the user terminal 200. Specifically, the user terminal 200 transmits icon IDs and drawing time of icons 230 that are actually displayed on the display screen 210, that is, icons 230 drawn on the display screen 210, among icons 230 of the product A, the product B, the product C, and so on and a product X, a product Y, a product Z, and so on that are arranged in a scrollable manner in the section “saved search condition” in the My List page illustrated as an example in FIG. 2, to the search device 100. Note that the displayed information acquirer 150 is an example of an acquirer and the icon ID and the drawing time are an example of drawn information.

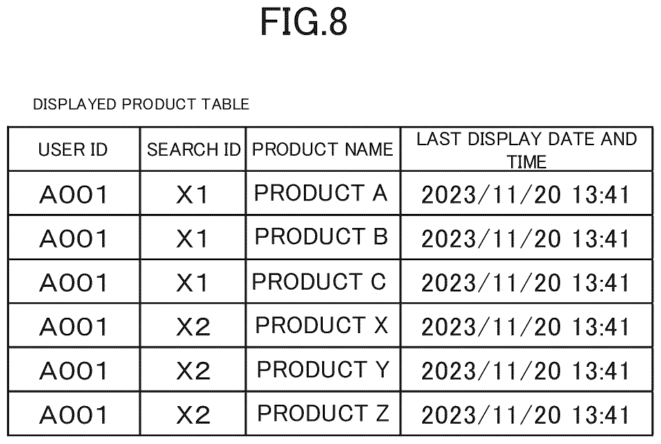

The displayed product table generator 160 generates a displayed product table that indicates products corresponding to icons 230 drawn on the display screen 210, with respect to each user and each saved search condition, based on the icon IDs and the drawing time that are acquired by the displayed information acquirer 150. An example of the displayed product table is illustrated in FIG. 8. The illustrated displayed product table is a displayed product table that is generated when in the section “saved search condition” on the display screen 210 illustrated as an example in FIG. 2, the icons 230 of the products A, B, and C and the icons 230 of the products X, Y, and Z are actually displayed as search results of the search keywords “bag” and “tops autumn winter”, respectively. The displayed product table includes pieces of information about the “user ID” for uniquely identifying a user, the “search ID” for uniquely identifying a search condition of each user, the “product name” indicating a name of a product corresponding to an icon 230 drawn on the display screen 210, and a “last display date and time” that is a date and time at which each icon 230 was last displayed. Note that the displayed product table may include a product ID in place of a product name or may include both a product name and a product ID. In addition, although in the illustrated example, displayed products of only the user “A001” are stored, displayed products of other users are likewise stored.

Returning to FIG. 4, the changer 170 changes the search result list generated by the searcher 140. Specifically, the changer 170 compares the search result list generated by the searcher 140 with the displayed product table generated by the displayed product table generator 160. The changer 170 identifies a product that is not included in the search result list among products corresponding to icons 230 that were drawn on the display screen 210 by a previous search processing that was performed using the same condition as the current search condition. The changer 170 changes the search result list by adding the identified product to the end of the search result list generated by the searcher 140. Specifics of processing performed by the changer 170 are described later.

The outputter 180 causes the user terminal 200 to display icons 230 of products included in the search result list on the display screen 210 of the user terminal 200, based on the search result list changed by the changer 170. In addition, when an icon 230 displayed on the display screen 210 is selected, the outputter 180 acquires link information of a web page in which detail information of a product corresponding to the selected icon 230 is displayed, from the product database 130, transmits the acquired link information to the user terminal 200, and causes the user terminal 200 to display the web page on the display screen 210.

### (Physical Configuration of Search Device)

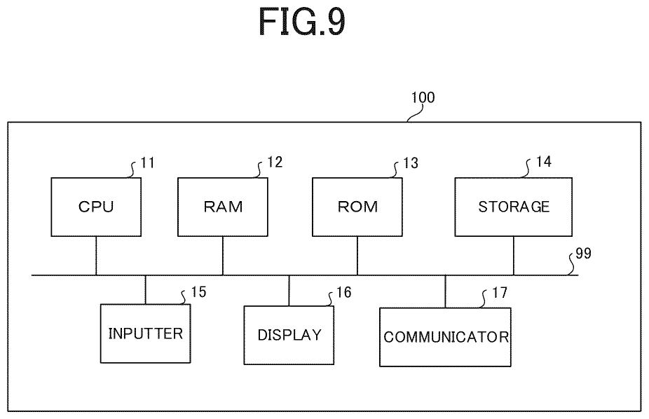

The search device 100, which has the above-described functional configuration, physically includes, as illustrated in FIG. 9, a central processing unit (CPU) 11 that performs processing in accordance with a program, a random access memory (RAM) 12 that is a volatile memory, a read only memory (ROM) 13 that is a non-volatile memory, a storage 14 that stores data, an inputter 15 that accepts input of information, a display 16 that visualizes and displays information, and a communicator 17 that performs transmission and reception of information, and the foregoing components are connected to one another via an internal bus 99. Note that the user terminal 200 may be configured to have a hardware configuration illustrated in FIG. 9.

The CPU 11 performs various types of processing by retrieving programs stored in the storage 14 to the RAM 12 and executing the programs. The CPU 11 performs respective types of processing performed by the search condition table generator 120, the searcher 140, the displayed product table generator 160, the changer 170, and the outputter 180 as principal functions provided by the programs. Note that the CPU 11 may be configured to perform respective types of processing performed by the search condition acquirer 110 and the displayed information acquirer 150.

The RAM 12 is used as a work area for the CPU 11. The ROM 13 stores a control program, a basic input output system (BIOS), and the like that the CPU 11 executes for basic operation of the search device 100.

The storage 14 includes a hard disk drive, stores programs that the CPU 11 executes, and stores various types of data that are used at the time of program execution. The storage 14 functions as the product database 130.

The inputter 15 is a user interface that includes a keyboard, a mouse, a communication device, and the like. The display 16 is a display device that visualizes and displays information, such as a liquid crystal display and an organic electro luminescence (EL) display.

The communicator 17 is a network terminal device or a radio communication device that is connected to a network and a serial interface or a local area network (LAN) interface that is connected to the network terminal device or the radio communication device. The communicator 17 functions as the search condition acquirer 110, the displayed information acquirer 150, and the outputter 180.

### (Search Condition Saving Processing)

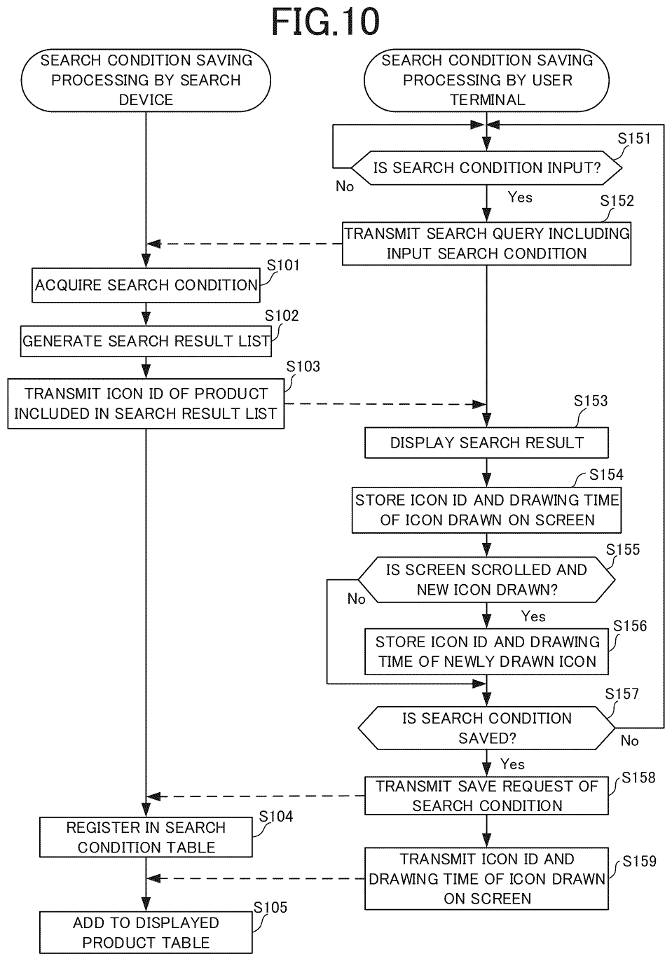

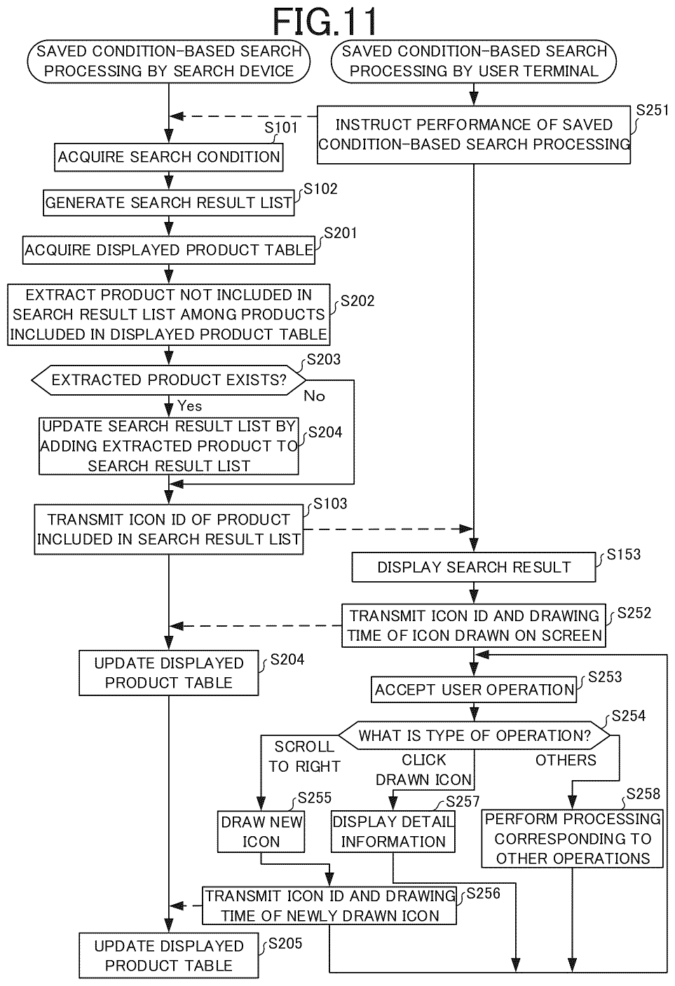

Succeedingly, operation of the search device 100 and the user terminal 200 is described with reference to FIGS. 10 and 11. First, search condition saving processing of saving a search condition, based on an input of a search keyword is described with reference to FIG. 10. When the user operates the user terminal 200, starts the electronic commerce app that is installed in the user terminal 200 in advance, and accesses a search page to search for a product, the search device 100 starts the search condition saving processing.

The user terminal 200 determines whether or not a search condition has been input (step S151). Specifically, the user terminal 200 determines whether or not a search keyword has been input to the search box 220, which accepts an input of a search keyword.

When the user terminal 200 determines that a search condition has been input to the search box 220 (step S151; Yes), the user terminal 200 transmits a search query including the input search condition to the search device 100 (step S152). For example, when the search keywords “kitchen storage” is input to the search box 220, the user terminal 200 transmits a search query having “kitchen storage” as a search condition to the search device 100. In contrast, when the user terminal 200 determines that no search condition has been input to the search box 220 (step S151; No), the user terminal 200 waits to receive an input of a search condition. Note that although a case where in step S151, the process proceeds to step S152 under the condition that a search keyword is input to the search box 220 was described, it may be configured such that the process proceeds to step S152 when a search keyword is input to the search box 220 and an operation indicating a search instruction is performed.

Next, the search condition acquirer 110 of the search device 100 acquires a search condition from the search query transmitted in step S152 (step S101). The search condition acquirer 110 transmits the acquired search condition to the searcher 140.

Next, the searcher 140 generates a search result list that indicates a list of products matching the search condition transmitted from the search condition acquirer 110 (step S102). Specifically, the searcher 140 searches index information that is stored in the product database 130 and that is illustrated as an example in FIG. 6, based on the search keyword and generates a search result list including a product matching the search condition. For example, when the search keywords are “kitchen storage”, the searcher 140 generates a search result list by extracting a product including a character string “kitchen storage” from the index information. Note that an extraction method of a product corresponding to a search keyword is not limited to the above-described method, and any method is applicable as long as the method enables a product to be identified, such as extracting a product including a character string similar to the search keyword. In addition, the search result list may be a list in which extracted products are ranked based on arbitrary information, such as a price, a registration date and time, and the number of registrations as favorites. The searcher 140 generates a search result list with the upper limit for the number of listed products set at a preset number of products, such as 20, 50, and 100, and stores the search result list in the storage 14.

Next, the outputter 180 transmits icon IDs of icons 230 of products included in the search result list generated by the searcher 140, in the listed order (step S103). Specifically, the outputter 180 acquires icon IDs of the products included in the search result list from the product database 130 and transmits the icon IDs to the user terminal 200 in an order determined in the search result list.

Next, the user terminal 200 displays the search result by displaying icons 230 corresponding to the icon IDs transmitted from the search device 100 on the display screen 210 (step S153). Specifically, the user terminal 200 acquires icons 230 corresponding to the icon IDs stored in the product database 130 from the search device 100. Next, the user terminal 200 displays the acquired icons 230 on the display screen 210 in a scrollable manner in a downward direction, as illustrated as an example in FIG. 3.

Next, the user terminal 200 stores, based on icons 230 of products AA to II having been drawn on the display screen 210, the icon 230 of the products AA to II having been displayed on the display screen 210 in a memory included in the user terminal 200. Specifically, the user terminal 200 stores icon IDs of the icons 230 of the products AA to II and time at which the icons 230 were drawn in the memory (step S154).

Next, the user terminal 200 determines whether or not, on the display screen 210 displayed in step S153, the user scrolls the display screen 210 and a new icon 230 is drawn (step S155). Specifically, when an icon 230 of a product after the product II is drawn on the display screen 210 by the user performing an operation of scrolling the display screen 210 in the downward direction, the user terminal 200 determines that a new icon 230 is drawn (step S155; Yes). Next, the user terminal 200 stores an icon ID of the icon 230 that is newly drawn and a time at which the icon 230 was drawn in the memory (step S156).

On the other hand, when a scroll operation is not performed, the user terminal 200 determines that no new icon 230 is drawn (step S155; No).

Next, the user terminal 200 determines whether or not to save the search condition input in step S151 (step S157). Specifically, when the user terminal 200 determines that the save button 250 arranged on the display screen 210 illustrated as an example in FIG. 3 is selected, the user terminal 200 determines to save the search condition (step S157; Yes) and transmits a request to save the search condition to the search device 100 (step S158). On the other hand, when the search keyword input in step S151 is deleted from the search box 220, another search keyword is input to the search box 220, or the like, the user terminal 200 determines not to save the search condition (step S157: No) and returns to step S151.

When the search condition table generator 120 receives a request to save the search condition transmitted in step S158, the search condition table generator 120 registers the search condition included in the search query transmitted in step S152 in the search condition table (step S104). Specifically, the search condition table generator 120 updates the search condition table illustrated as an example in FIG. 5 by providing a search ID to the search keywords “kitchen storage” transmitted in step S152 and adding the search keywords to the latest search condition table. The illustrated example indicates that the search condition table is updated by adding a search condition based on the new search keywords “kitchen storage” to the search condition table in which search conditions having search IDs “X1” and “X2” have been saved.

Next, the user terminal 200 transmits the icon IDs of the displayed icons 230 and the time at which the respective icons 230 were drawn on the display screen 210 that are stored in the memory to the search device 100 (step S159). Note that when an icon 230 is newly drawn between the processing in steps S158 and S159, the user terminal 200 transmits the icon IDs and drawing the time of the drawn icons 230 including an icon ID of the newly drawn icon 230 and a time at which the icon 230 was drawn, to the search device 100. In addition, after step S159, the user terminal 200 may wait to receive a scroll operation from the user and transmit an icon ID of a newly drawn icon 230 and a time at which the icon 230 was drawn to the user terminal 200 as required until the search keyword input in step S151 is deleted from the search box 220 or another search keyword is input to the search box 220.

Next, the displayed product table generator 160 registers the icon IDs and drawing time transmitted in step S159 in the displayed product table, which indicates a list of products that have been displayed, with respect to each user and each search condition (step S105). Specifically, the displayed product table generator 160 updates the displayed product table by acquiring a product name corresponding to each received icon ID with reference to the product database 130 and adding the acquired product names, the user IDs, the search IDs, and time at which the icons 230 were drawn in association with one another to the displayed product table, and stores the updated displayed product table in the storage 14.

### (Saved Condition-Based Search Processing)

Next, with reference to FIG. 11, saved condition-based search processing of performing a product search, based on a saved search condition performed by the search device 100 is described. Note that since a flowchart in FIG. 11 includes steps common to the flowchart illustrated as an example in FIG. 10, the following description is made focusing on differences.

When the user starts the electronic commerce app and accesses the My List page, the user terminal 200 instructs the search device 100 to perform the saved condition-based search processing (step S251). Note that when the user terminal 200 instructs the performance of the saved condition-based search processing, the user terminal 200 transmits a search condition to the search device 100.

Next, when the search condition acquirer 110 receives a performance instruction of the saved condition-based search processing from the user terminal 200, the search condition acquirer 110 acquires a search condition table with respect to the user for which the processing is to be performed from the storage 14 in step S101 (step S101) and transmits the search condition table to the searcher 140. Next, the searcher 140 searches for a product matching the search condition received in step S101 and generates a search result list by similar processing to the processing in step S102 in FIG. 10 (step S102).

Next, as illustrated as an example in FIG. 8, the changer 170 acquires a displayed product table that indicates products corresponding to icons 230 drawn on the display screen 210 in a previous search, from the storage 14 (step S201).

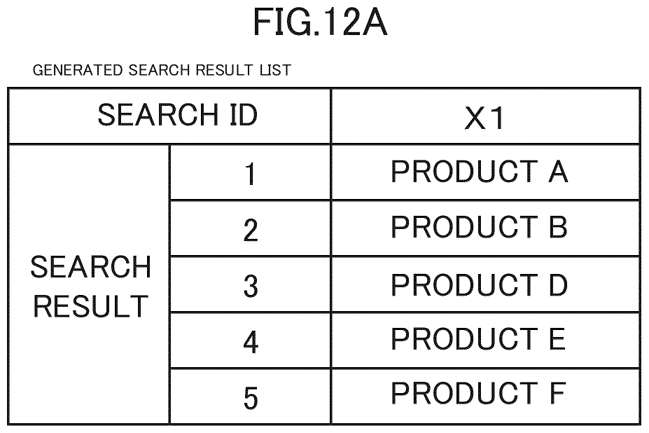

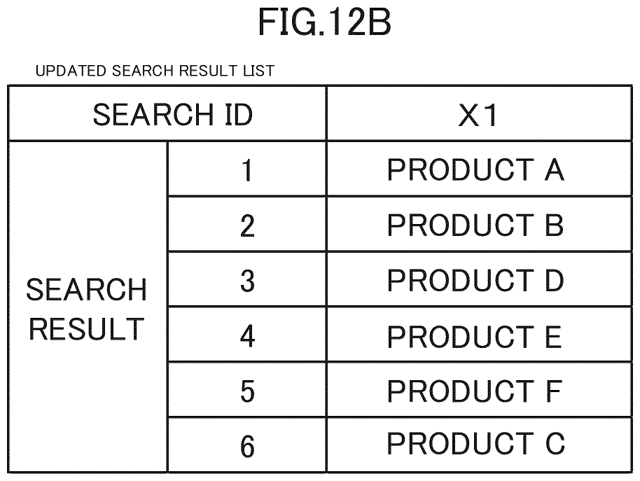

Next, the changer 170 extracts a product that is not included in the search result list generated in step S102 from the products included in the displayed product table (step S202). Specifically, the changer 170 compares the search result list with the displayed product table and extracts a product that is not included in the search result list from the products included in the displayed product table. An example of a search result list based on a search condition having a search ID “X1” that is generated in step S102 is illustrated in FIG. 12A. The changer 170 compares the displayed product table under the search condition having the search ID “X1” illustrated as an example in FIG. 8 with the search result list illustrated as an example in FIG. 12A and extracts the product C that is not included in the search result list. When the changer 170 determines that there exists an extracted product (step S203; Yes), the changer 170 updates the search result list by adding the extracted product to the search result list (step S204). Specifically, the changer 170 adds the product C to the end of the search result list illustrated as an example in FIG. 12A. An example of the search result list that is updated by the changer 170 is illustrated in FIG. 12B. The changer 170 stores the updated search result list in the storage 14. Note that when there exists a plurality of products that, although not included in the search result list, have been drawn once in the past, the changer 170 adds all of such products to the end of the search result list. In addition, the addition of a product to the search result list is not limited to addition to the end of the search result list, and a product may be added to the top of the search result list or may be added to another arbitrary point.

Note that when in step S203, the changer 170 determines that there exists no extracted product (step S203; No), the changer 170 determines not to update the search result list generated in step S102 and proceeds to step S103.

Next, the outputter 180 transmits the icon IDs of the icons 230 of the products included in the search result list to the user terminal 200 in an order determined in the search result list by similar processing to the processing in step S103 in FIG. 10 (step S103).

Next, the user terminal 200 displays the search result on the display screen 210 by similar processing to the processing in step S153 in FIG. 10 (step S153). Next, the user terminal 200 transmits the icon IDs and drawing time of the icons 230 drawn first on the display screen 210, to the search device 100 (step S252).

Next, the displayed product table generator 160 of the search device 100 updates the displayed product table, based on the icon IDs and drawing time transmitted in step S252 (step S205). Specifically, when, for example, an icon ID of a new product that is not included in the latest displayed product table is included in the transmitted icon IDs, the displayed product table generator 160 adds the new product to the displayed product table. In addition, when, for example, an icon ID of a product that is included in the latest displayed product table is included in the transmitted icon IDs, the displayed product table generator 160 updates the last display date and time of the product in the displayed product table with the drawing time transmitted in step S252. Note that the displayed product table may keep only information within a preset period, and the displayed product table generator 160 may compare a current date and time with the last display date and time of each product and delete a product that falls outside the preset period from the displayed product table. For example, a product that has been kept in the displayed product table for more than one week since the last display date and time maybe deleted from the displayed product table.

Next, the user terminal 200 accepts an operation performed by the user (step S253) and identifies a type of the operation performed by the user (step S254). When the user terminal 200 identifies that the operation performed by the user is an operation of scrolling the display screen 210 in the right direction in the area in which icons 230 are displayed, the user terminal 200 draws an icon 230 of a new product on the display screen 210 in response to the operation of scrolling (step S255). Next, the user terminal 200 transmits an icon ID and drawing time of the newly drawn icon 230 to the search device 100 (step S256) and returns to step S253.

Next, when the displayed product table generator 160 of the search device 100 receives the icon ID and drawing time of the icon 230 that is newly drawn in step S256, the displayed product table generator 160 updates the displayed product table by similar processing to the processing in step S205 (step S206).

On the other hand, returning to step S254, when the user terminal 200 identifies that the operation performed by the user is an operation of selecting an icon 230 drawn on the display screen 210, from the product database 130, the user terminal 200 acquires link information of a product corresponding to the selected icon 230, displays a web page for displaying detail information of the product on the display screen 210 (step S257), and returns to step S253.

In addition, when, in step S254, the user terminal 200 identifies that the operation performed by the user is an operation other than the scroll operation and the operation of selecting an icon 230, the user terminal 200 performs processing corresponding to the operation performed by the user (step S258). For example, when the user performs an operation of clicking a white heart mark included in an icon 230 of a product not registered as a favorite, the user terminal 200 performs processing of changing the white heart mark to a black heart mark. Alternatively, when the user selects the icon 240a for transition to the home screen or the icon 240b for transition to the screen to search for a product, the user terminal 200 transitions to a page corresponding to each icon and once terminates the saved condition-based search processing. When the icon 240c for transition to the My List page is selected in the home screen or a product search screen, the saved condition-based search processing is to be performed again.

As described above, when the search device 100 performs search processing, based on a saved search condition, the search device 100 determines whether or not a product that was actually displayed on the display screen 210 of the user terminal 200 by previous search processing is included in a current search result. When the search device 100 determines that a product having been displayed in previous search processing is not included in the current search result, the search device 100 updates the search result by adding the product to the search result and displays the updated search result on the user terminal 200. Therefore, the user becomes able to reconsider information having been displayed in a previous search again at the time of re-searching. For example, there is a case where after the search device 100 first performs the search processing under some search condition, information about a product is added and when a search is performed under the search condition again, a search result is different from the search result of the previous search processing due to a reason that an upper limit is defined for the number of searched products, or the like. In this case, the search device 100 adding a search result displayed on the user terminal 200 at the time of the first search to a search result at the time of re-searching enables the user to reconsider information having been displayed in the previous search.

### Variations

Although in the above-described embodiment, a search condition is assumed to be a search keyword input by the user, the present disclosure is not limited to the embodiment. For example, the search condition may be a search condition for a search for a product or a service that a store or a seller registered as a favorite by the user newly puts up for sale or a search for a product or a service that another user registered as a favorite by the user registers as a favorite. Every time the user accesses the My List page, a search result may be displayed in the section “following”, as illustrated as an example in FIG. 2. In this case, the search device 100 is only required to save a date and time at which a product was put up for sale, a date and time at which the user registers a product or a service as a favorite, and the like in the database, acquire such information from the database at the time of performing the search processing, and search for a product that is newly put up for sale in a period from the previous search processing to the current search processing or a product that a favorite user newly registers as a favorite. The search device 100 is only required to determine whether or not a product corresponding to an icon 230 having been drawn in the previous search processing is included in the search result list by performing the same processing as the processing in steps S201 to S203 in FIG. 11 and add a product that is determined not to be included in the search result list to the search result list and cause the user terminal 200 to display the search result list.

In addition, although in the above-described embodiment, when the user accesses the My List page, the user terminal 200 is assumed to instruct performance of the saved condition-based search processing, the present disclosure is not limited to the embodiment, and the user terminal 200 may instruct the performance of the saved condition-based search processing in the background at a preset timing, such as once a day and once a week. In this case, the search device 100 generates a search result list by performing the processing in steps S101 to S204 in FIG. 11. When the user accesses the My List page, the search device 100 is only required to perform the processing in step S103, based on the generated search result list and cause the user terminal 200 to display the search result.

In addition, although in the above-described embodiment, the search device 100 is assumed to include the search condition table generator 120 and the displayed product table generator 160, the user terminal 200 may generate the search condition table and the displayed product table. In this case, the search device 100 does not have to include the search condition table generator 120 and the displayed product table generator 160. Specifically, in step S158 in the search condition saving processing illustrated in FIG. 10, the user terminal 200 generates or updates the search condition table illustrated as an example in FIG. 4, based on the search condition input in step S151 and saves the search condition table in the memory. In addition, the user terminal 200 is only required to acquire a product name corresponding to an icon 230 drawn on the display screen 210 from the product database 130 with the icon ID as a key, generate or update the displayed product table illustrated as an example in FIG. 8, and save the displayed product table in the memory in steps S154 and S156 in FIG. 10 and steps S252 and S257 in FIG. 11. In step S251 in the saved condition-based search processing illustrated in FIG. 11, the user terminal 200 is only required to transmit a search query including the search condition table and the displayed product table to the search device 100 and cause the search device 100 to perform the saved condition-based search processing.

In addition, although in the above-described embodiment, only search conditions of the user having the user ID “A001” are stored in the search condition table in FIG. 5, search conditions of other users are also likewise saved in the table, and when a saved condition-based search with respect to some user is performed, the search device 100 extracts a search condition from the search condition table, using an user ID of the user, performs a search with respect to each extracted search condition, and causes a user terminal 200 of the user to display a result of the search.

Note that the search device 100 according to the above-described embodiment can be achieved using a general computer without depending on a dedicated device. For example, the search device 100 that performs the above-described processing may be configured by installing, from a non-transitory recording medium storing a program to cause the computer to perform one of the above-described types of processing, the program in the computer. In addition, the search device 100 may be configured by a plurality of computers operating in collaboration with one another.

In addition, when the above-described functions are achieved by sharing of operation between an operating system (OS) and an application or collaboration between the OS and the application, only programs other than the OS may be stored in the medium.

In addition, it is possible to superimpose programs on a carrier wave and distribute the programs via a communication network. For example, the programs may be distributed at an app store for a smartphone or the programs may be posted on a bulletin board system (BBS) on the communication network and distributed via the network. It may be configured such that the above-described processing can be performed by starting the distributed programs and executing the programs in a similar manner to other application programs under the control of the operating system.

In addition, information that the storage 14 stores may be collectively managed by a cloud server existing on the network, and the search device 100 may access the cloud server and perform reading and writing of information on a needed basis. In this case, the search device 100 does not have to include the product database 130. In addition, the search condition saving processing and the saved condition-based search processing performed by the search device 100 may be performed on the cloud, using information stored in the cloud server.

Hereinafter, various modes of embodiment of the present disclosure are collectively described as Appendices.

### APPENDIX 1

A search device, comprising one or more processors,
wherein the processors
perform a conditional search to search for an object matching a search condition and generate a list including the object,
cause a user terminal to display the object included in the generated list on a display screen of the user terminal,
acquire drawn information indicating the object that is drawn on the display screen among the objects included in the list, and
in a case where the acquired drawn object is not included in a new list generated by newly performing the conditional search based on the search condition, add the drawn object to the new list.

### APPENDIX 2

The search device according to appendix 1, wherein the processors in a case where all the objects included in the list cannot be collectively drawn on the display screen, cause all the objects to be drawn on the display screen by causing the display screen to be scrolled.

### APPENDIX 3

The search device according to appendix 2, wherein the processors acquire the drawn information including the object that is drawn on an initial screen, the initial screen being a screen on which the object that is found by performing the conditional search is first displayed, and the object that is drawn on the display screen by causing the display screen to be scrolled.

### APPENDIX 4

The search device according to any one of appendices 1 to 3, wherein
the object is a product or a service that serves as a trading object in electronic commerce, and
the search condition includes a condition for extracting a product or a service that another user who is registered as a favorite by a user register as a favorite.

### APPENDIX 5

The search device according to any one of appendices 1 to 3, wherein
the object is a product or a service that serves as a trading object in electronic commerce, and
the search condition includes a condition for extracting a product or a service that a store or a seller registered as a favorite by a user is putting up for sale.

### APPENDIX 6

The search device according to any one of appendices 1 to 5, wherein the processors,
when the object drawn on the display screen is selected, cause detail information of the selected object to be displayed on the display screen.

### APPENDIX 7

A search method causing a computer to perform processing comprising:
performing a conditional search to search for an object matching a search condition and generating a list including the object;
causing a user terminal to display the object included in the generated list on a display screen of the user terminal;
acquiring drawn information indicating the object that is drawn on the display screen among the objects included in the list; and
in a case where in generation of the list, the acquired drawn object is not included in a new list generated by newly performing the conditional search based on the search condition, adding the drawn object to the new list.

### APPENDIX 8

A non-transitory computer-readable recording medium storing a program for causing a computer to perform processing comprising:
performing a conditional search to search for an object matching a search condition and generating a list including the object;
causing a user terminal to display the object included in the generated list on a display screen of the user terminal;
acquiring drawn information indicating the object that is drawn on the display screen among the objects included in the list; and
in a case where in generation of the list, the acquired drawn object is not included in a new list generated by newly performing the conditional search based on the search condition, adding the drawn object to the new list.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

The present disclosure can be suitably employed for a search device, a search method, and a recording medium that display information having been displayed in a previous search again at the time of re-searching.

1. A search device, comprising one or more processors,
wherein the processors
perform a conditional search to search for an object matching a search condition and generate a list including the object,
cause a user terminal to display the object included in the generated list on a display screen of the user terminal,
acquire drawn information indicating the object that is drawn on the display screen among the objects included in the list, and
in a case where the acquired drawn object is not included in a new list generated by newly performing the conditional search based on the search condition, add the drawn object to the new list.

2. The search device according to claim 1, wherein the processors in a case where all the objects included in the list cannot be collectively drawn on the display screen, cause all the objects to be drawn on the display screen by causing the display screen to be scrolled.

3. The search device according to claim 2, wherein the processors acquire the drawn information including the object that is drawn on an initial screen, the initial screen being a screen on which the object that is found by performing the conditional search is first displayed, and the object that is drawn on the display screen by causing the display screen to be scrolled.

4. The search device according to claim 1, wherein
the object is a product or a service that serves as a trading object in electronic commerce, and
the search condition includes a condition for extracting a product or a service that another user who is registered as a favorite by a user register as a favorite.

5. The search device according to claim 1, wherein
the object is a product or a service that serves as a trading object in electronic commerce, and
the search condition includes a condition for extracting a product or a service that a store or a seller registered as a favorite by a user is putting up for sale.

6. The search device according to claim 1, wherein the processors,
when the object drawn on the display screen is selected, cause detail information of the selected object to be displayed on the display screen.

7. A search method causing a computer to perform processing comprising:
performing a conditional search to search for an object matching a search condition and generating a list including the object;
causing a user terminal to display the object included in the generated list on a display screen of the user terminal;
acquiring drawn information indicating the object that is drawn on the display screen among the objects included in the list; and
in a case where in generation of the list, the acquired drawn object is not included in a new list generated by newly performing the conditional search based on the search condition, adding the drawn object to the new list.

8. A non-transitory computer-readable recording medium storing a program for causing a computer to perform processing comprising:
performing a conditional search to search for an object matching a search condition and generating a list including the object;
causing a user terminal to display the object included in the generated list on a display screen of the user terminal;
acquiring drawn information indicating the object that is drawn on the display screen among the objects included in the list; and
in a case where in generation of the list, the acquired drawn object is not included in a new list generated by newly performing the conditional search based on the search condition, adding the drawn object to the new list.
